(19) United States
(12) Patent Application Publication
(10) Pub. No.: US 2026/0145514 A1
(43) Pub. Date: May 28, 2026

(54) METHOD OF CONTROLLING POWER TRANSFER DEVICE FOR VEHICLE

(71) Applicant: HYUNDAI WIA CORPORATION, Changwon-si (KR)

(72) Inventors: Jong Chan LEE, Changwon-si (KR); Hyeon Ho PARK, Changwon-si (KR)

(21) Appl. No.: 19/392,516

(22) Filed: Nov. 18, 2025

(30) Foreign Application Priority Data
Nov. 27, 2024 (KR) 10-2024-0171625

(51) Int. Cl. B60K 23/08; B60K 17/02; B60K 17/16; B60K 17/356; B60K 23/04; B60L 15/20

(52) U.S. Cl. CPC B60K 23/08; B60K 17/02; B60K 17/165; B60K 17/20; B60K 17/356; B60K 23/04; B60L 15/20; B60K 2023/046; B60L 2240/421; B60L 2240/461

(57) ABSTRACT

Disclosed is a method of controlling a power transfer device for a vehicle, which includes a traction motor that transfers power to auxiliary drive wheels of the vehicle including main and auxiliary drive wheels; a traction motor control unit that controls the traction motor; a case that rotates upon receiving the power generated from the traction motor; a first side gear that is connected to a first wheel of the auxiliary drive wheels; a second side gear that is connected to a second wheel of the auxiliary drive wheels; a pinion gear that meshes with the first side gear and the second side gear; a cage that supports the pinion gear and is configured to rotate relative to the case; and a disconnect actuator system (DAS) that includes a lock plate supported by the case to come into contact with or be separated from the cage.

### CROSS REFERENCE TO RELATED APPLICATION

This application is based on and claims priority under 35 U.S.C. § 119 to Korean Patent Application No. 10-2024-0171625, filed on Nov. 27, 2024, in the Korean Intellectual Property Office, the disclosure of which is incorporated by reference herein in its entirety.

### BACKGROUND OF THE INVENTION

### Field of the Invention

The disclosure relates to a method of controlling a power transfer device for a vehicle.

### Description of the Related Art

In general, vehicles are driven by sending power generated from a power source, such as an engine or a motor, to the wheels, and such a drivetrain system for the vehicles is classified into a two-wheel drive system that powers either the front or rear wheels, and a four-wheel drive system that powers both the front and rear wheels.

The four-wheel drive system provides greater driving stability than the two-wheel drive system and is more suitable for off-road driving such as driving in mountainous terrain. The four-wheel drive system is classified into an all-wheel drive system and a part-time four-wheel drive system.

The part-time four-wheel drive system employs a power transfer device to distribute power between the front and rear wheels.

The power transfer device includes a disconnect actuator system (DAS) for switching between the two-wheel drive and the four-wheel drive, and a limited slip differential (LSD) for preventing a situation in which the vehicle becomes unable to move because more and more power is transferred to the wheels with low traction and no power is transferred to the wheels with high traction during the four-wheel drive.

In addition, the power transfer device further includes a DAS controller for controlling the DAS, and an LSD controller for controlling the LSD, and is controlled by a method of controlling the power transfer device for a vehicle, in which the DAS controller and the LSD controller are controlled separately.

Because the DAS controller and the LSD controller are controlled separately in such a conventional method of controlling the power transfer device for a vehicle, conflicts occur between the control of the DAS and the control of the LSD, thereby causing shock or damage.

### SUMMARY OF THE INVENTION

Accordingly, an aspect of the disclosure is to provide a method of controlling a power transfer device for a vehicle, which can prevent conflicts between control of a disconnect actuator system (DAS) and control of a limited slip differential (LSD), thereby avoiding shock or damage.

According to an embodiment, there is provided a method of controlling a power transfer device for a vehicle, which includes a traction motor that transfers power to auxiliary drive wheels of the vehicle including main and auxiliary drive wheels; a traction motor control unit that controls the traction motor; a case that rotates upon receiving the power generated from the traction motor; a first side gear that is connected to a first wheel of the auxiliary drive wheels; a second side gear that is connected to a second wheel of the auxiliary drive wheels; a pinion gear that meshes with the first side gear and the second side gear; a cage that supports the pinion gear and is configured to rotate relative to the case; a disconnect actuator system (DAS) that includes a lock plate supported by the case to come into contact with or be separated from the cage; a DAS controller that controls the DAS; a limited slip differential (LSD) that includes a drum operatively connectable to the case, a first clutch disc coupled to the drum, a second clutch disc rotatable together with the second side gear, and a hydraulic device configured to engage and disengage the first clutch disc and the second clutch disc; and an LSD controller that controls the LSD, the method including performing sequence control for the traction motor control unit, the DAS controller and the LSD controller of the power transfer device.

The method may further include: a drive mode determination step of determining a drive mode; a first sequence control step of operating the traction motor control unit, the DAS controller, and the LSD controller based on a predetermined first sequence control to perform a transition to a four-wheel drive mode upon determining the transition from a two-wheel drive mode to the four-wheel drive mode in the drive mode determination step; and a second sequence control step of operating the traction motor control unit, the DAS controller, and the LSD controller based on a predetermined second sequence control to perform a transition to the two-wheel drive mode upon determining the transition from the four-wheel drive mode to the two-wheel drive mode in the drive mode determination step.

The drive mode determination step may include: a first drive mode determination step of determining whether a drive mode received from a vehicle control unit (VCU) is the two-wheel drive mode or the four-wheel drive mode; a second drive mode determination step of determining whether the current drive mode is the two-wheel drive mode or the four-wheel drive mode upon determining, in the first drive mode determination step, that the received drive mode is the four-wheel drive mode; and a third drive mode determination step of determining whether the current drive mode is the two-wheel drive mode or the four-wheel drive mode upon determining, in the first drive mode determination step, that the received drive mode is the two-wheel drive mode, and the determination of the two-wheel drive mode in the second drive mode determination step may be regarded as the transition from the two-wheel drive mode to the four-wheel drive mode, and thus the first sequence control step may be performed, and the determination of the four-wheel drive mode in the third drive mode determination step may be regarded as the transition from the four-wheel drive mode to the two-wheel drive mode, and thus the second sequence control step may be performed.

The first sequence control step may include: a traction motor—auxiliary drive wheel speed synchronization step of synchronizing the speed of the traction motor with the speed of the auxiliary drive wheel through the traction motor control unit; a DAS engagement step of synchronizing the case with the cage by bringing the lock plate into contact with the cage through the DAS controller; an LSD responsiveness securing step of securing the responsiveness of the LSD by increasing the pressure of the hydraulic device through the LSD controller; and an LSD driving torque control step of controlling the driving torque of the LSD by adjusting the pressure of the hydraulic device based on driving conditions through the LSD controller.

The traction motor—auxiliary drive wheel speed synchronization step may include: a traction motor auxiliary drive wheel speed synchronization attempt step of adjusting the speed of the traction motor through the traction motor control unit; and a traction motor—auxiliary drive wheel speed synchronization determination step of determining whether a difference between the speed of the traction motor and the speed of the auxiliary drive wheel falls within a predetermined speed range, the traction motor—auxiliary drive wheel speed synchronization determination step may be performed after the traction motor—auxiliary drive wheel speed synchronization attempt step, the DAS engagement step and the LSD responsiveness securing step may be performed upon determining, in the traction motor auxiliary drive wheel speed synchronization determination step, that the difference between the speed of the traction motor and the speed of the auxiliary drive wheel falls within the predetermined speed range, and the traction motor auxiliary drive wheel speed synchronization attempt step may be performed again upon determining that the difference between the speed of the traction motor and the speed of the auxiliary drive wheel does not fall within the predetermined speed range.

The DAS engagement step may include: a DAS engagement attempt step of moving the lock plate closer to the cage through the DAS controller; a DAS engagement determination step of determining whether a movement distance of the lock plate falls within a predetermined distance range; and a DAS engagement signal transmission step of transmitting a DAS engagement signal indicating that the case is in synchronization with the cage, the DAS engagement determination step may be performed after the DAS engagement attempt step, the DAS engagement signal transmission step and the LSD driving torque control step may be sequentially performed upon determining, in the DAS engagement determination step, that the movement distance of the lock plate falls within the predetermined distance range, and the DAS engagement attempt step may be performed again upon determining, in the DAS engagement determination step, that the movement distance of the lock plate does not fall within the predetermined distance range.

The LSD responsiveness securing step may include: an LSD responsiveness securing attempt step of increasing the pressure of the hydraulic device through the LSD controller; and an LSD responsiveness securing determination step of determining whether the pressure of the hydraulic device falls within a predetermined pressure range, the LSD responsiveness securing determination step may be performed after the LSD responsiveness securing attempt step, the DAS engagement determination step may be performed upon determining, in the LSD responsiveness securing determination step, that the pressure of the hydraulic device falls within the predetermined pressure range, and the LSD responsiveness securing attempt step may be performed again upon determining, in the LSD responsiveness securing determination step, that the pressure of the hydraulic device does not fall within the predetermined pressure range.

The DAS engagement determination step may be performed upon performing the DAS engagement attempt step and determining, in the LSD responsiveness securing determination step, that the pressure of the hydraulic device falls within the predetermined pressure range.

The minimum value of the predetermined pressure range may be set greater upon a low responsiveness of the LSD than upon a high responsiveness of the LSD.

The second sequence control step may include: a DAS disengagement step of desynchronizing the case with the cage by separating the lock plate from the cage through the DAS controller; an LSD pressure release determination step of releasing the pressure of the hydraulic device through the LSD controller; and an LSD driving torque non-control step in which the driving torque of the LSD is not controlled.

The DAS disengagement step may include: a DAS disengagement attempt step of moving the lock plate away from the cage through the DAS controller; a DAS disengagement determination step of determining whether the movement distance of the lock plate falls within a predetermined distance range; and a DAS disengagement signal transmission step of transmitting a DAS disengagement signal indicating that the case is out of synchronization with the cage, the DAS disengagement determination step may be performed after the DAS disengagement attempt step, the DAS disengagement signal transmission step and the LSD driving torque non-control step may be sequentially performed upon determining, in the DAS disengagement determination step, that the movement distance of the lock plate falls within the predetermined distance range, and the DAS disengagement attempt step may be performed again upon determining, in the DAS disengagement determination step, that the movement distance of the lock plate does not fall within the predetermined distance range.

The LSD pressure release step may include: an LSD pressure release attempt step of decreasing the pressure of the hydraulic device through the LSD controller; and an LSD pressure release determination step of comparing the pressure of the hydraulic device with a predetermined pressure, the LSD pressure release attempt step may be performed after the DAS disengagement attempt step, the LSD pressure release determination step may be performed after the LSD pressure release attempt step, the DAS disengagement determination step may be performed upon determining, in the LSD pressure release determination step, that the pressure of the hydraulic device is lower than the predetermined pressure, and the LSD pressure release attempt step may be performed again upon determining, in the LSD pressure release determination step, that the pressure of the hydraulic device is higher than or equal to the predetermined pressure.

In the LSD pressure release attempt step, the pressure of the hydraulic device may be decreased by a method selected between a method using a motor and a method using gravity and clutch churning.

The method may further include an LSD driving torque control step of controlling the driving torque of the LSD by adjusting the pressure of the hydraulic device based on driving conditions through the LSD controller, upon determining, in the drive mode determination step, that the four-wheel drive mode which was a previous drive mode is to be maintained.

The method may further include an LSD driving torque non-control step in which the driving torque of the LSD is not controlled, upon determining, in the drive mode determination step, that the two-wheel drive mode which was a previous drive mode is to be maintained.

### BRIEF DESCRIPTION OF THE DRAWINGS

FIG. 1 is a flowchart showing a part of a method of controlling a power transfer device for a vehicle according to an embodiment of the disclosure,

FIG. 2 is a flowchart showing another part of the method of controlling the power transfer device for a vehicle in FIG. 1,

FIG. 3 is a flowchart showing still another part of the method of controlling a power transfer device for a vehicle in FIG. 1,

FIG. 4 is a system diagram showing a power transfer device for a vehicle controlled in a two-wheel drive mode by the method of controlling the power transfer device for a vehicle shown in FIGS. 1 to 3,

FIG. 5 is a system diagram showing a power transfer device for a vehicle controlled in a four-wheel drive mode by the method of controlling the power transfer device for a vehicle shown in FIGS. 1 to 3, and

FIG. 6 is a system diagram showing a power transfer device for a vehicle controlled in a four-wheel drive and differential limiting mode by the method of controlling the power transfer device for a vehicle shown in FIGS. 1 to 3.

### DETAILED DESCRIPTION OF THE INVENTION

Below, a method of controlling a power transfer device for a vehicle according to the disclosure will be described in detail with reference to the accompanying drawings.

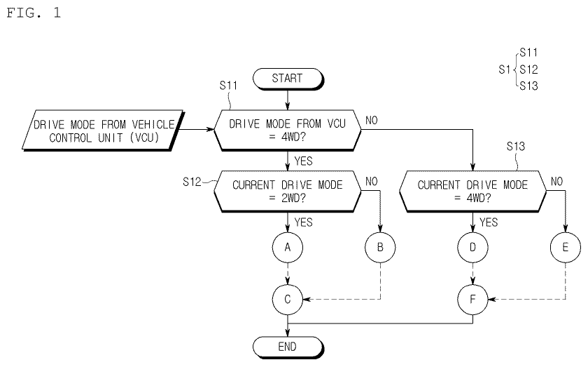

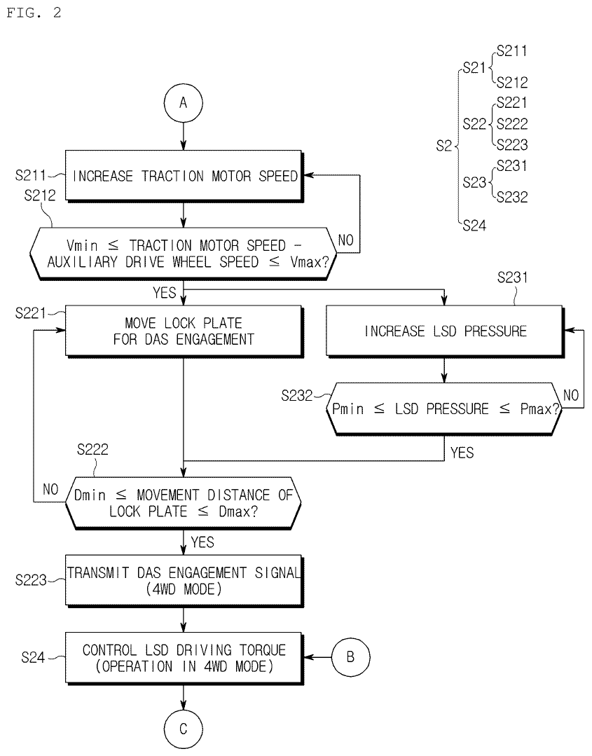

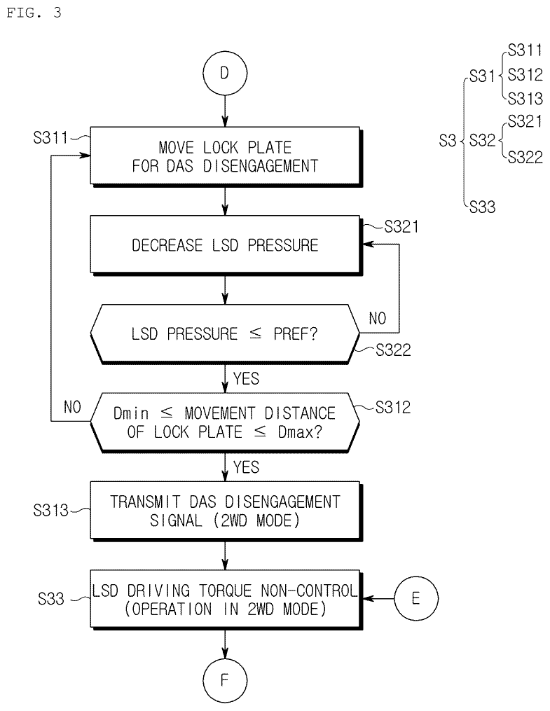

FIG. 1 is a flowchart showing a part of a method of controlling a power transfer device for a vehicle according to an embodiment of the disclosure, FIG. 2 is a flowchart showing another part of the method of controlling the power transfer device for a vehicle in FIG. 1, FIG. 3 is a flowchart showing still another part of the method of controlling a power transfer device for a vehicle in FIG. 1, FIG. 4 is a system diagram showing a power transfer device for a vehicle controlled in a two-wheel drive mode by the method of controlling the power transfer device for a vehicle shown in FIGS. 1 to 3, FIG. 5 is a system diagram showing a power transfer device for a vehicle controlled in a four-wheel drive mode by the method of controlling the power transfer device for a vehicle shown in FIGS. 1 to 3, and FIG. 6 is a system diagram showing a power transfer device for a vehicle controlled in a four-wheel drive and differential limiting mode by the method of controlling the power transfer device for a vehicle shown in FIGS. 1 to 3.

Referring to FIGS. 1 to 6, the power transfer device for a vehicle according to an embodiment of the disclosure may include a traction motor for transferring power to the auxiliary drive wheels of the vehicle having main and auxiliary drive wheels, and a traction motor control unit for controlling the traction motor.

In addition, the power transfer device for a vehicle may further include a case 100 that rotates upon receiving the power generated from the traction motor, a first side gear 200 that is connected to a first wheel of the auxiliary drive wheels, a second side gear 300 that is connected to a second wheel of the auxiliary drive wheels, a pinion gear 400 that meshes with the first side gear 200 and the second side gear 300, a cage 500 that supports the pinion gear 400 and is provided to rotate relative to the case 100, a disconnect actuator system (DAS) 600 that includes a lock plate 610 supported by the case 100 to come into contact with or be separated from the cage 500, and a DAS controller that controls the DAS 600.

In addition, the power transfer device for a vehicle further includes a limited slip differential (LSD) 700 that prevents a situation in which the vehicle becomes unable to move because more and more power is transferred to the wheels with low traction and no power is transferred to the wheels with high traction in the four-wheel drive mode, and an LSD controller that controls the LSD 700. The LSD 700 may include a drum 710 operatively connectable to the case 100, a first clutch disc coupled to the drum 710, a second clutch disc rotatable together with the second side gear 300, and a hydraulic device configured to engage and disengage the first clutch disc and the second clutch disc.

Here, the first clutch disc and the second clutch disc constitute a clutch pack 720.

Meanwhile, the power transfer device for a vehicle is controlled by a method of controlling the power transfer device for a vehicle according to this embodiment. The method of controlling the power transfer device for a vehicle may include performing sequence control for the traction motor control unit, the DAS controller, and the LSD controller.

Specifically, the method of controlling the power transfer device for a vehicle according to this embodiment may include a drive mode determination step S1 of determining a drive mode.

The drive mode determination step S1 may include a first drive mode determination step S11 of determining whether a drive mode received from a vehicle control unit (VCU) is the two-wheel drive mode or the four-wheel drive mode, a second drive mode determination step S12 of determining whether the current drive mode is the two-wheel drive mode or the four-wheel drive mode when the received drive mode is determined to be the four-wheel drive mode in the first drive mode determination step S11, and a third drive mode determination step S13 of determining whether the current drive mode is the two-wheel drive mode or the four-wheel drive mode when the received drive mode is determined to be the two-wheel drive mode in the first drive mode determination step S11.

In addition, the method of controlling the power transfer device for a vehicle may further include a first sequence control step S2 of operating the traction motor control unit, the DAS controller, and the LSD controller based on a predetermined first sequence control to perform a transition to the four-wheel drive mode when the transition from the two-wheel drive mode to the four-wheel drive mode is determined in the drive mode determination step S1.

The first sequence control step S2 may include a traction motor—auxiliary drive wheel speed synchronization step S21 of synchronizing the speed of the traction motor with the speed of the auxiliary drive wheel through the traction motor control unit.

The traction motor—auxiliary drive wheel speed synchronization step S21 may include a traction motor auxiliary drive wheel speed synchronization attempt step S211 of adjusting the speed of the traction motor through the traction motor control unit.

In addition, the traction motor—auxiliary drive wheel speed synchronization step S21 may further include a traction motor—auxiliary drive wheel speed synchronization determination step S212 of determining whether a difference between the speed of the traction motor and the speed of the auxiliary drive wheel falls within a predetermined speed range.

In addition, the first sequence control step S2 may further include a DAS engagement step S22 of synchronizing the case 100 with the cage 500 by bringing the lock plate 610 into contact with the cage 500 through the DAS controller.

The DAS engagement step S22 may include a DAS engagement attempt step S221 of moving the lock plate 610 closer to the cage 500 through the DAS controller.

In addition, the DAS engagement step S22 may further include a DAS engagement determination step S222 of determining whether a movement distance of the lock plate 610 falls within a predetermined distance range.

In addition, the DAS connection step S22 may further include a DAS engagement signal transmission step S223 of transmitting a DAS engagement signal indicating that the case 100 is in synchronization with the cage 500.

In addition, the first sequence control step S2 may further include an LSD responsiveness securing step S23 of securing the responsiveness of the LSD 700 by increasing the pressure of the hydraulic device through the LSD controller.

The LSD responsiveness securing step S23 may include an LSD responsiveness securing attempt step S231 of increasing the pressure of the hydraulic device through the LSD controller.

In addition, the LSD responsiveness securing step S23 may further include an LSD responsiveness securing determination step S232 of determining whether the pressure of the hydraulic device falls within a predetermined pressure range.

Here, the predetermined pressure range may be appropriately set according to the responsiveness characteristics of the LSD. In other words, for example, the minimum value Pmin of the predetermined pressure range may be set greater when the responsiveness of the LSD 700 is low (when a high preload is required to secure the responsiveness) than when the responsiveness of the LSD 700 is high (when sufficient responsiveness can be secured even with a low preload).

In addition, the first sequence control step S2 may further include an LSD driving torque control step S24 of controlling the driving torque of the LSD 700 by adjusting the pressure of the hydraulic device based on driving conditions through the LSD controller.

In addition, the method of controlling the power transfer device for a vehicle may further include a second sequence control step S3 of operating the traction motor control unit, the DAS controller, and the LSD controller based on a predetermined second sequence control to perform a transition to the two-wheel drive mode when the transition from the four-wheel drive mode to the two-wheel drive mode is determined in the drive mode determination step S1.

The second sequence control step S3 may include a DAS disengagement step S31 of desynchronizing the case 100 with the cage 500 by separating the lock plate 610 from the cage 500 through the DAS controller.

The DAS disengagement step S31 may include a DAS disengagement attempt step S311 of moving the lock plate 610 away from the cage 500 through the DAS controller.

In addition, the DAS disengagement step S31 may further include a DAS disengagement determination step S312 of determining whether the movement distance of the lock plate 610 falls within a predetermined distance range.

In addition, the DAS disengagement step S31 may further include a DAS disengagement signal transmission step S313 of transmitting a DAS disengagement signal indicating that the case 100 is out of synchronization with the cage 500.

In addition, the second sequence control step S3 may further include an LSD pressure release step S32 of releasing the pressure of the hydraulic device through the LSD controller.

The LSD pressure release step S32 may include an LSD pressure release attempt step S321 of decreasing the pressure of the hydraulic device through the LSD controller.

Here, in the LSD pressure release attempt step S321, the pressure of the hydraulic device may be decreased by a method selected between a method using a motor, which is disadvantageous in terms of noise and side effects but advantageous in terms of pressure release speed, and a method using gravity and clutch churning, which is disadvantageous in terms of pressure release speed but advantageous in terms of noise and side effects.

In addition, the LSD pressure release step S32 may further include an LSD pressure release determination step S322 of comparing the pressure of the hydraulic device with a predetermined pressure.

In addition, the second sequence control step S3 may further include an LSD driving torque non-control step S33 in which the driving torque of the LSD 700 is not controlled.

Here, when the current drive mode is determined to be the two-wheel drive mode in the second drive mode determination step S12, it is regarded as the transition from the two-wheel drive mode to the four-wheel drive mode, and thus the first sequence control step S2 may be performed.

On the other hand, when the current drive mode is determined to be the four-wheel drive mode in the second drive mode determination step S12, it is regarded as the maintenance of the previous drive mode, i.e., the four-wheel drive mode, and thus the LSD driving torque control step S24 may be performed.

In addition, when the current drive mode is determined to be the four-wheel drive mode in the third drive mode determination step S13, it is regarded as the transition from the four-wheel drive mode to the two-wheel drive mode, and thus the second sequence control step S3 may be performed.

On the other hand, when the current drive mode is determined to be the two-wheel drive mode in the third drive mode determination step S13, it is regarded as the maintenance of the previous drive mode, i.e., the two-wheel drive mode, and thus the LSD driving torque non-control step S33 may be performed.

Meanwhile, in the first sequence control step S2, the traction motor—auxiliary drive wheel speed synchronization determination step S212 may be performed after the traction motor—auxiliary drive wheel speed synchronization attempt step S211.

In addition, when it is determined in the traction motor—auxiliary drive wheel speed synchronization determination step S212 that the difference between the speed of the traction motor and the speed of the auxiliary drive wheel falls within the predetermined speed range, the DAS engagement step S22 and the LSD responsiveness securing step S23 may be performed.

On the other hand, when it is determined that the difference between the speed of the traction motor and the speed of the auxiliary drive wheel does not fall within the predetermined speed range, the traction motor—auxiliary drive wheel speed synchronization attempt step S211 may be performed again.

Further, in the first sequence control step S2, the DAS engagement determination step S222 may be performed after the DAS engagement attempt step S221.

In addition, when it is determined in the DAS engagement determination step S222 that the movement distance of the lock plate 610 falls within the predetermined distance range, the DAS engagement signal transmission step S223 and the LSD driving torque control step S24 may be sequentially performed.

On the other hand, when it is determined in the DAS engagement determination step S222 that the movement distance of the lock plate 610 does not fall within the predetermined distance range, the DAS engagement attempt step S221 may be performed again.

Further, in the first sequence control step S2, the LSD responsiveness securing determination step S232 may be performed after the LSD responsiveness securing attempt step S231.

In addition, when it is determined in the LSD responsiveness securing determination step S232 that the pressure of the hydraulic device falls within the predetermined pressure range, the DAS engagement determination step S222 may be performed.

On the other hand, when it is determined in the LSD responsiveness securing determination step S232 that the pressure of the hydraulic device does not fall within the predetermined pressure range, the LSD responsiveness securing attempt step S231 may be performed again.

Here, the DAS engagement determination step S222 may be performed when the DAS engagement attempt step S221 is performed and it is determined in the LSD responsiveness securing determination step S232 that the pressure of the hydraulic device falls within the predetermined pressure range.

Meanwhile, in the second sequence control step S3, the DAS disengagement determination step S312 may be performed after the DAS disengagement attempt step S311.

In addition, when it is determined in the DAS disengagement determination step S312 that the movement distance of the lock plate 610 falls within the predetermined distance range, the DAS disengagement signal transmission step S313 and the LSD driving torque non-control step S33 may be sequentially performed.

On the other hand, when it is determined in the DAS disengagement determination step S312 that the movement distance of the lock plate 610 does not fall within the predetermined distance range, the DAS disengagement attempt step S311 may be performed again.

Further, in the second sequence control step S3, the LSD pressure release attempt step S321 may be performed after the DAS disengagement attempt step S311.

In addition, the LSD pressure release determination step S322 may be performed after the LSD pressure release attempt step S321.

In addition, when it is determined in the LSD pressure release determination step S322 that the pressure of the hydraulic device is lower than the predetermined pressure, the DAS disengagement determination step S312 may be performed.

On the other hand, when it is determined in the LSD pressure release determination step S322 that the pressure of the hydraulic device is higher than or equal to the predetermined pressure, the LSD pressure release attempt step S321 may be performed again.

Below, the operational effects of the method of controlling the power transfer device for a vehicle according to an embodiment will be described.

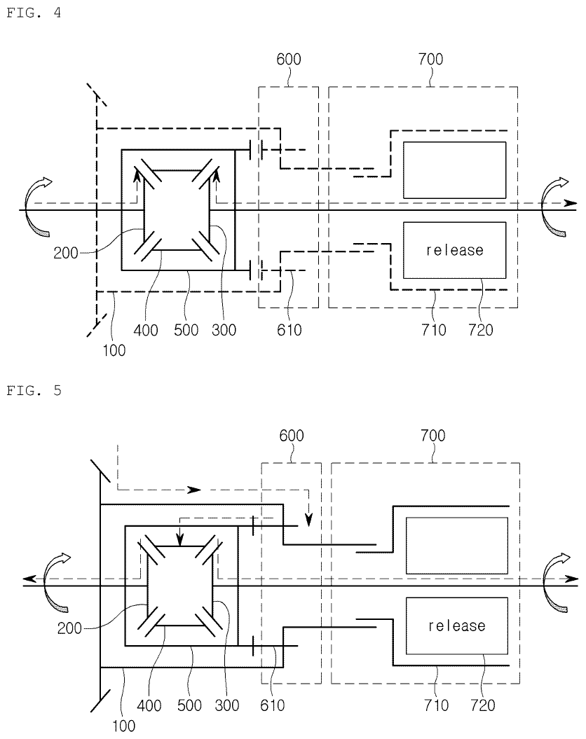

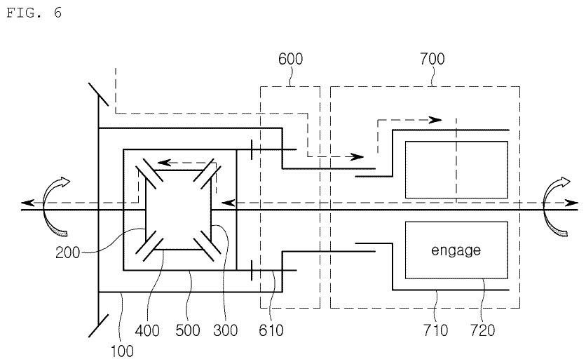

That is, when the vehicle is being driven in the two-wheel drive mode shown in FIG. 4, a transition command to the four-wheel drive mode may be received from the vehicle control unit. Then, as shown in FIG. 1, the first sequence control step S2 may be performed carrying out the first drive mode determination step S11 and the second drive mode determination step S12. Then, as shown in FIG. 2, the traction motor-auxiliary drive wheel speed synchronization step S21 may be performed so that the speed of the traction motor can be synchronized with the speed of the auxiliary drive wheel. Then, the DAS engagement step S22 and the LSD responsiveness securing step S23 may be performed simultaneously. When the responsiveness of the LSD 700 is secured to complete the engagement of the DAS 600, the LSD driving torque control step S24 is performed so that the vehicle can be driven in the four-wheel drive mode of FIG. 5 or the four-wheel drive and differential limiting mode of FIG. 6.

Here, in the case of the four-wheel drive mode shown in FIG. 5, the case 100 and the drum 710 are not coupled. In the case of the four-wheel drive and differential limiting mode shown in FIG. 6, the case 100 and the drum 710 are coupled and constrained by a spline of a drive shaft that connects the second side gear 300 and the second wheel.

When a command to drive in the four-wheel drive mode is received from the vehicle control unit, but the current drive mode is the four-wheel drive mode, the LSD driving torque control step S24 being currently performed may continue to be performed. In other words, as shown in FIGS. 1 and 2, the LSD driving torque control step S24 may be performed directly after performing the first drive mode determination step S11 and the second drive mode determination step S12.

When the vehicle is driven in the four-wheel drive mode of FIG. 5 or the four-wheel drive and differential limiting mode of FIG. 6, a transition command to the two-wheel drive mode may be received from the vehicle control unit. Then, as shown in FIG. 1, the second sequence control step S3 may be performed carrying out the first drive mode determination step S11 and the third drive mode determination step S13. Then, as shown in FIG. 3, the DAS disengagement step S31 and the LSD pressure release step S32 may be performed. In addition, when the pressure of the LSD 700 is released to complete the disengagement of the DAS 600, the LSD driving torque non-control step S33 is performed so that the vehicle can be driven in the two-wheel drive mode of FIG. 4.

When a command to drive in the two-wheel drive mode is received from the vehicle control unit, but the current drive mode is the two-wheel drive mode, the LSD driving torque non-control step S33 being currently performed may continue to be performed. In other words, as shown in FIGS. 1 and 3, the LSD driving torque non-control step S33 may be performed directly after performing the first drive mode determination step S11 and the third drive mode determination step S13.

Here, the method of controlling the power transfer device for a vehicle according to an embodiment may include performing the sequence control for the traction motor control unit, the DAS controller, and the LSD controller to prevent conflicts between the control of the DAS 600 and the control of the LSD 700, thereby avoiding shock or damage.

In particular, the method of controlling the power transfer device for a vehicle includes the first sequence control step S2, and the first sequence control step S2 includes the traction motor—auxiliary drive wheel speed synchronization attempt step S211, the traction motor auxiliary drive wheel speed synchronization determination step S212, the DAS engagement attempt step S221, the DAS engagement determination step S222, the DAS engagement signal transmission step S223, the LSD responsiveness securing attempt step S231, the LSD responsiveness securing determination step S232, and the LSD driving torque control step S24, which are integrally and interrelatedly connected according to a predetermined first sequence control, thereby effectively avoiding the shock or damage upon the transition from the two-wheel drive mode to the four-wheel drive mode or the four-wheel drive and differential limiting mode.

In addition, the method of controlling the power transfer device for a vehicle includes the second sequence control step S3, and the second sequence control step S3 includes the DAS disengagement attempt step S311, the DAS disengagement determination step S312, the DAS disengagement signal transmission step S313, the LSD pressure release attempt step S321, the LSD pressure release determination step S322, and the LSD driving torque non-control step S33, which are integrally and interrelatedly connected according to a predetermined second sequence control, thereby effectively avoiding the shock or damage upon the transition from the four-wheel drive mode or the four-wheel drive and differential limiting mode to the two-wheel drive mode.

What is claimed is:

1. A method of controlling a power transfer device for a vehicle, which comprises a traction motor that transfers power to auxiliary drive wheels of the vehicle comprising main and auxiliary drive wheels; a traction motor control unit that controls the traction motor; a case that rotates upon receiving the power generated from the traction motor; a first side gear that is connected to a first wheel of the auxiliary drive wheels; a second side gear that is connected to a second wheel of the auxiliary drive wheels; a pinion gear that meshes with the first side gear and the second side gear; a cage that supports the pinion gear and is configured to rotate relative to the case; a disconnect actuator system (DAS) that includes a lock plate supported by the case to come into contact with or be separated from the cage; a DAS controller that controls the DAS; a limited slip differential (LSD) that comprises a drum operatively connectable to the case, a first clutch disc coupled to the drum, a second clutch disc rotatable together with the second side gear, and a hydraulic device configured to engage and disengage the first clutch disc and the second clutch disc; and an LSD controller that controls the LSD, the method comprising performing sequence control for the traction motor control unit, the DAS controller and the LSD controller of the power transfer device.

2. The method of claim 1, further comprising:
a drive mode determination step of determining a drive mode;
a first sequence control step of operating the traction motor control unit, the DAS controller, and the LSD controller based on a predetermined first sequence control to perform a transition to a four-wheel drive mode upon determining the transition from a two-wheel drive mode to the four-wheel drive mode in the drive mode determination step; and
a second sequence control step of operating the traction motor control unit, the DAS controller, and the LSD controller based on a predetermined second sequence control to perform a transition to the two-wheel drive mode upon determining the transition from the four-wheel drive mode to the two-wheel drive mode in the drive mode determination step.

3. The method of claim 2, wherein
the drive mode determination step comprises:
a first drive mode determination step of determining whether a drive mode received from a vehicle control unit (VCU) is the two-wheel drive mode or the four-wheel drive mode;
a second drive mode determination step of determining whether the current drive mode is the two-wheel drive mode or the four-wheel drive mode upon determining, in the first drive mode determination step, that the received drive mode is the four-wheel drive mode; and
a third drive mode determination step of determining whether the current drive mode is the two-wheel drive mode or the four-wheel drive mode upon determining, in the first drive mode determination step, that the received drive mode is the two-wheel drive mode, and
the determination of the two-wheel drive mode in the second drive mode determination step is regarded as the transition from the two-wheel drive mode to the four-wheel drive mode, and thus the first sequence control step is performed, and
the determination of the four-wheel drive mode in the third drive mode determination step is regarded as the transition from the four-wheel drive mode to the two-wheel drive mode, and thus the second sequence control step is performed.

4. The method of claim 2, wherein
the first sequence control step comprises:
a traction motor—auxiliary drive wheel speed synchronization step of synchronizing the speed of the traction motor with the speed of the auxiliary drive wheel through the traction motor control unit;
a DAS engagement step of synchronizing the case with the cage by bringing the lock plate into contact with the cage through the DAS controller;
an LSD responsiveness securing step of securing the responsiveness of the LSD by increasing the pressure of the hydraulic device through the LSD controller; and
an LSD driving torque control step of controlling the driving torque of the LSD by adjusting the pressure of the hydraulic device based on driving conditions through the LSD controller.

5. The method of claim 4, wherein
the traction motor—auxiliary drive wheel speed synchronization step comprises:
a traction motor—auxiliary drive wheel speed synchronization attempt step of adjusting the speed of the traction motor through the traction motor control unit; and
a traction motor—auxiliary drive wheel speed synchronization determination step of determining whether a difference between the speed of the traction motor and the speed of the auxiliary drive wheel falls within a predetermined speed range,
the traction motor—auxiliary drive wheel speed synchronization determination step is performed after the traction motor—auxiliary drive wheel speed synchronization attempt step,
the DAS engagement step and the LSD responsiveness securing step are performed upon determining, in the traction motor—auxiliary drive wheel speed synchronization determination step, that the difference between the speed of the traction motor and the speed of the auxiliary drive wheel falls within the predetermined speed range, and
the traction motor—auxiliary drive wheel speed synchronization attempt step is performed again upon determining that the difference between the speed of the traction motor and the speed of the auxiliary drive wheel does not fall within the predetermined speed range.

6. The method of claim 4, wherein
the DAS engagement step comprises:
a DAS engagement attempt step of moving the lock plate closer to the cage through the DAS controller;
a DAS engagement determination step of determining whether a movement distance of the lock plate falls within a predetermined distance range; and
a DAS engagement signal transmission step of transmitting a DAS engagement signal indicating that the case is in synchronization with the cage,
the DAS engagement determination step is performed after the DAS engagement attempt step,
the DAS engagement signal transmission step and the LSD driving torque control step are sequentially performed upon determining, in the DAS engagement determination step, that the movement distance of the lock plate falls within the predetermined distance range, and
the DAS engagement attempt step is performed again upon determining, in the DAS engagement determination step, that the movement distance of the lock plate does not fall within the predetermined distance range.

7. The method of claim 6, wherein
the LSD responsiveness securing step comprises:
an LSD responsiveness securing attempt step of increasing the pressure of the hydraulic device through the LSD controller; and
an LSD responsiveness securing determination step of determining whether the pressure of the hydraulic device falls within a predetermined pressure range,
the LSD responsiveness securing determination step is performed after the LSD responsiveness securing attempt step,
the DAS engagement determination step is performed upon determining, in the LSD responsiveness securing determination step, that the pressure of the hydraulic device falls within the predetermined pressure range, and
the LSD responsiveness securing attempt step is performed again upon determining, in the LSD responsiveness securing determination step, that the pressure of the hydraulic device does not fall within the predetermined pressure range.

8. The method of claim 7, wherein the DAS engagement determination step is performed upon performing the DAS engagement attempt step and determining, in the LSD responsiveness securing determination step, that the pressure of the hydraulic device falls within the predetermined pressure range.

9. The method of claim 7, wherein the minimum value of the predetermined pressure range is set greater upon a low responsiveness of the LSD than upon a high responsiveness of the LSD.

10. The method of claim 2, wherein
the second sequence control step comprises:
a DAS disengagement step of desynchronizing the case with the cage by separating the lock plate from the cage through the DAS controller;
an LSD pressure release determination step of releasing the pressure of the hydraulic device through the LSD controller; and
an LSD driving torque non-control step in which the driving torque of the LSD is not controlled.

11. The method of claim 10, wherein
the DAS disengagement step comprises:
a DAS disengagement attempt step of moving the lock plate away from the cage through the DAS controller;
a DAS disengagement determination step of determining whether the movement distance of the lock plate falls within a predetermined distance range; and
a DAS disengagement signal transmission step of transmitting a DAS disengagement signal indicating that the case is out of synchronization with the cage,
the DAS disengagement determination step is performed after the DAS disengagement attempt step,
the DAS disengagement signal transmission step and the LSD driving torque non-control step are sequentially performed upon determining, in the DAS disengagement determination step, that the movement distance of the lock plate falls within the predetermined distance range, and
the DAS disengagement attempt step is performed again upon determining, in the DAS disengagement determination step, that the movement distance of the lock plate does not fall within the predetermined distance range.

12. The method of claim 11, wherein
the LSD pressure release step comprises:
an LSD pressure release attempt step of decreasing the pressure of the hydraulic device through the LSD controller; and
an LSD pressure release determination step of comparing the pressure of the hydraulic device with a predetermined pressure,
the LSD pressure release attempt step is performed after the DAS disengagement attempt step,
the LSD pressure release determination step is performed after the LSD pressure release attempt step,
the DAS disengagement determination step is performed upon determining, in the LSD pressure release determination step, that the pressure of the hydraulic device is lower than the predetermined pressure, and
the LSD pressure release attempt step is performed again upon determining, in the LSD pressure release determination step, that the pressure of the hydraulic device is higher than or equal to the predetermined pressure.

13. The method of claim 12, wherein, in the LSD pressure release attempt step, the pressure of the hydraulic device is decreased by a method selected between a method using a motor and a method using gravity and clutch churning.

14. The method of claim 2, further comprising an LSD driving torque control step of controlling the driving torque of the LSD by adjusting the pressure of the hydraulic device based on driving conditions through the LSD controller, upon determining, in the drive mode determination step, that the four-wheel drive mode which was a previous drive mode is to be maintained.

15. The method of claim 2, further comprising an LSD driving torque non-control step in which the driving torque of the LSD is not controlled, upon determining, in the drive mode determination step, that the two-wheel drive mode which was a previous drive mode is to be maintained.
